(19) United States
(12) Patent Application Publication
(10) Pub. No.: US 2007/0212208 A1
(43) Pub. Date: Sep. 13, 2007

(54) Device and Method for Supplying Stackable Goods

(76) Inventors: Rudolf Hansl, Linz (AT); Dieter Klug, Treffelstein (DE)

Correspondence Address: WILLIAM COLLARD;COLLARD & ROE, P.C., 1077 NORTHERN BOULEVARD, ROSLYN, NY, 11576, US

(21) Appl. No.: 10/593,196

(22) PCT Filed: Mar. 9, 2005
(86) PCT No.: PCT/AT05/00082

§ 371 Date: Feb. 6, 2007

(30) Foreign Application Priority Data
Mar. 18, 2004 (AT) A 482/2004

(51) Int. Cl. B65G 57/00

(52) U.S. Cl. 414/788.7; 198/345.1; 359/107; 398/118; 414/154; 414/296; 455/151.2; 455/3.03; 700/244; 700/95; 718/101

(57) ABSTRACT

The invention relates to a system (1) and a method of dispensing stackable objects (2), comprising a storage unit (4) and actuatable discharge mechanisms (21) as well as a detection system (30), whereby the storage unit (4) has shaft-type dispenser magazines (13) disposed in its longitudinal direction aligned one after the other in a row, from which the objects (2) are dispensed, and the discharge mechanisms (21) are provided at the bottom end (20) of each dispenser magazine (13). The detection system (30) has a measuring unit, by means of which the distance between the uppermost object (2) lying farthest away from the discharge mechanism (21) and a top level limit (42) of a dispenser magazine (13) is measured, and from this, the level of objects (2) or an actual stock level of objects (2) in at least some of the dispenser magazines (13) is calculated. In a preferred embodiment, the measuring unit is mounted on a control carriage (32) disposed above the top ends of the dispenser magazines (13) which can be displaced horizontally between the dispenser magazines (13).

The invention relates to a system and a method for dispensing stackable objects in shaft-type dispenser magazines of at least one storage unit and monitoring the level in the dispenser magazines by means of a detection system, of the type described in the introductory parts of claims 1, 19, 20 and 21.

Patent specification U.S. 5,755,552 A discloses a system for dispensing stackable objects. This system is designed as a so-called consignment plant and has a conveyor belt which can be driven in one direction at a constant speed and storage units disposed at each side of it in the conveying direction, as well as an adjoining, transversely extending conveyor system at a discharge end of the conveyor belt. The two storage units are each formed by elongate, shaft-type, dispenser magazines disposed one after the other in a row in their longitudinal direction, inside which the objects to be consigned are stacked one on top of the other. A discharge mechanism controlled by a computer system is disposed at the bottom end of each dispenser magazine, by means of which the respective lowermost object can be dispensed from the dispenser magazine. The shaft-type dispenser magazine is filled with the objects by hand or automatically and form a stack.

Consignments of objects can be prepared in two different ways. In a first system described in patent specification DE 33 48 171 C, object holders intended for consignments, in particular transport containers, deposited on a conveyor belt are conveyed past a plurality of dispenser magazines disposed on either side of the belt conveyor and are filled with different objects based on a predefined order as they are fed past the dispenser magazines.

By contrast, in a different system described in patent specification DE 42 25 041 A, no holders are used for the objects to be consigned and instead, the individual objects are grouped on the basis of orders and deposited directly on the conveyor belt passing underneath the dispenser magazines of a storage system. The individual orders are transferred to a second conveyor belt fed past the discharge end of the first conveyor belt and from there are pushed off into object containers for the individual orders.

The individual dispenser magazines also have level displays to enable the individual dispenser magazines to be scanned so that the operating personnel of the plant can be issued with a signal indicating which dispenser magazine must be topped up again. To this end, a switch or photoelectric barrier is provided in every dispenser magazine, which transmits a signal to a control unit as soon as the stack falls below a minimum level. The computer system, which counts every item as it is dispensed, can then run a reconciliation between the known count and the height of the remaining stack.

Another design of level indicator is known from patent specification DE 35 33 382 A1, whereby a counting unit is provided at the top and bottom end of each dispenser magazine for the objects introduced into the dispenser magazine and the objects discharged from it. By means of these counting units, the respective objects introduced and discharged are counted and the computer system detects the actual status and thus the number of items in the dispenser magazine. A display can then be output at the control system, indicating whether there is an adequate number of objects in the relevant dispenser magazine or whether there is a risk that these objects will shortly all have run out, thus requiring the objects to be topped up. Since these known consignment plants often have to operate with up to several hundred dispenser magazines, highly complex switching technology is necessarily needed to enable the level in each dispenser magazine to be monitored reliably.

However, by far the biggest disadvantage of the known level monitoring systems resides in the fact that the operator always fills only the dispenser magazines at which a message in the form of an alarm has just been issued, indicating that the dispenser magazines need filling, on a non-selective basis, and at this stage, the operator is not aware which dispenser magazines absolutely have to be topped up. As a result, there is no way of guaranteeing that the operator will fill, as a matter of urgency (based on priority), those dispenser magazines which must contain a sufficient stock of the objects to be commissioned to enable an order or subsequent orders to be met correctly. If an order or subsequent orders can not be met, part of the consignment plant must be stopped.

Patent specification DE 27 36 197 A1 also discloses an electronically controlled, automated consignment system, which has a storage system with several vertical shaft-type dispenser magazines disposed adjacent to one another. The dispenser magazines are filled on an automated basis by means of a conveyor system. The dispenser magazines are each fitted with sensors, by means of which an actual stock level of objects is detected, after which the actual stock level of objects is compared with a desired stock level of objects needed for an order and the actual stock level of objects is reconciled. The dispenser magazines are topped up with only a quantity of objects needed for processing the order, thereby enabling an economic batch size to be prepared. When a dispenser magazine is filled to a maximum, the objects being conveyed by the conveyor system are taken out of the control loop and returned to the feed circuit.

Finally, patent specification DE 197 45 813 A discloses a system and a method of determining the level of objects in a dispenser magazine of an automatic vending machine, where a measuring scale, in particular a bar code, is disposed in the dispenser magazine. The measuring scale is covered by the objects up to a current level and the reading region of the measuring scale corresponding to the current level can be scanned by means of an optoelectronic reading device, in particular a bar code reading device. The reading device assigns the individual dimensions of an object to a dispenser magazine, as a result of which the number of objects in the dispenser magazine can be calculated, based on the level to which it is full.

The objective of the invention is to propose a system and a method of dispensing stackable objects and monitoring the level in dispenser magazines, which are distinctive due to a simple control system and reliable operation and permit coordinated filling of the dispenser magazines with objects.

The objective of the invention is achieved on the basis of the features defined in the characterizing part of claim 1. The advantage of this approach is that the measuring unit is disposed on a control carriage displaceably guided above the storage unit in its longitudinal direction between the individual dispenser magazines, and the distance between the uppermost object and an upper level limit of a dispenser magazine can therefore be detected and the level in the respective dispenser magazine determined using only one measuring unit for each storage unit. This avoids the highly complex switching technology involved in the known system of providing measuring units on every dispenser magazine, which reduces the cost of the system as a whole and results in reliable operation.

Also of advantage are the embodiments defined in claims 2 and 3, whereby the control carriage is guided along the guide track with little clearance and thus enables a reliable measurement to of the distance between the uppermost object in a dispenser magazine and a pre-defined upper level limit to be obtained.

Advantageous embodiments of the drive system are described in claim 4.

Advantageous embodiments of measuring units are described in claims 5 to 7. They are distinctive primarily due to their high measuring accuracy and short response times.

The embodiments defined in claims 8 to 11 permit the exact positioning of the control carriage relative to the individual dispenser magazines on the one hand and the detection of its current actual position, on the other hand, thereby enabling a detected, preferably electric measurement signal pertaining to a distance, which is used to determine the level, to be accurately assigned to the respective dispenser magazine.

The embodiments of the invention defined in claims 12 and 13 are of advantage because this disposition of the storage units and the conveyor system provide a simple way of enabling a range of different objects to be sorted into consignments based on pre-defined orders.

The embodiment defined in claim 14 is also of advantage because the fact that the guide sections are inclined towards the middle of the conveyor system provides access to the dispenser magazines whilst requiring a minimum amount of space and makes it much easier to top up the dispenser magazines manually. Due to the twofold inclined disposition of the guide sections, there is no need to provide a guide system for the objects on all sides in the dispenser magazines. This also obviates the need to adapt the size of the dispenser magazines to the size of the respective objects.

The embodiment defined in claim 15 is of advantage because the system proposed by the invention is made up of the support frame, guide track and modular, interchangeable dispenser magazines, and the guide sections constituting the dispenser magazines form a practical top-up opening for the objects across their entire length, thereby enabling an operator to fill the dispenser magazines easily by hand.

Another advantageous embodiment of the invention is defined in claim 16. Accordingly, the measurement signals pertaining to the distance can be transmitted to a control system of the computer system or to a control unit for further processing/evaluation.

As defined in claim 17, it is of advantage that the operator can be provided with information at the output device, for example as regards which dispenser magazines need topping up, the current number of objects (actual stock level) contained in the respective dispenser magazine, which type (sort) of object is being dispensed from the respective dispenser magazine, how many objects are still needed based on the input orders/predicted sales quantity within a set time window or period, when a dispenser magazine will have to be topped up and such like. Furthermore, the operator also has the possibility of activating a topping-up operation from the input device or stopping a consignment operation in the event of error functions/faults, for example.

Another advantageous embodiment of the invention is defined in claim 18, whereby data and/or measurement or control signals are transmitted by means of a radio transmission system or an infrared transmission system between the measuring unit and/or the control system and/or the control unit and/or the at least one drive motor without contact, thereby enabling the use of a relatively simple control system to meet requirements.

The objective of the invention is also achieved on the basis of the features defined in the characterizing part of claim 19. The surprising advantage gained as a result is that the distance between the uppermost object and the maximum, upper level limit can be detected simultaneously with the movement of the control carriage by means of preferably only one measuring unit per storage unit, at least in one of the dispenser magazines, and the level in it determined, thereby significantly reducing the complexity of the control system.

The objective of the invention is also achieved on the basis of the features defined in the characterizing part of claim 20. The major advantage of this approach is that a demand message is not issued to the operator unless the actual stock level of objects of a dispenser magazine is too low and a detected order can therefore not be correctly satisfied. In other words, the computer system firstly runs a check to ascertain what number (desired demand) of objects is needed for this detected order and then runs a comparison to ascertain whether the contents of the dispenser magazine are sufficient to process the order. If this order can not be fulfilled, a demand message is issued to the operator. This takes place before or during the processing of this order and even before the dispenser magazine has been completely emptied, thereby ruling out stoppage of the system. If the dispenser magazine still contains sufficient objects for this order, no demand message is issued. However, this may also mean that there are still only a few objects in the dispenser magazine but the actual stock level of objects is still sufficient and the order can be fulfilled. A demand message is not issued until another order for the same object is entered and the actual stock level of objects is not enough. This being the case, the operator will not receive a demand message unless a top-up operation is actually necessary rather than receiving one as soon as the quantity falls below a minimum level, as is the case with the systems known from the prior art, irrespective of whether more objects are actually needed in order to complete this and possibly a subsequent order. This correlation of the determined actual stock level in the dispenser magazine with the order means that the number of demand messages issued to the operator is minimal, thus relieving the operator. The demand message may also contain information such as the number of objects needed to complete the order correctly and the time window within which a top-up will be needed without the risk of this dispenser magazine being totally emptied. This offers the operator another option for coordinating the filling operations.

The objective of the invention is also achieved on the basis of the features described in the characterizing part of claim 21. The advantage of this is that, using a predicted sales quantity of at least one type of object within a specific time window, the required quantity of this object is determined and the planning of resources can be delegated to operators on the basis of this demand. The output values for the projected sales quantity of an object can be determined using statistical evaluations or by means of values based on experience and entered in the computer system as a quantitative amount.

The features defined in claim 22 are of advantage because the predicted sales quantity of various different objects can also be pre-defined and the operator informed of the desired demand for them, thereby resulting in top-up operations accordingly. To this end, the operator is provided with information via the control unit, for example the number of objects which must be delivered to the dispenser magazines.

Another advantageous feature is defined in claim 23, whereby, for an order, the levels in all the dispenser magazines containing the objects for this order are measured and the operator has to fill only those dispenser magazines for which the demand calculated for the order is higher than the number of objects available.

Another feature of the invention is defined in claim 24. The advantage of this is that the total demand of objects for all orders is determined and if the actual stock level of objects for fulfilling all the orders correctly is not sufficient, the operator is prompted to top up the respective dispenser magazine. This means that as soon as there is a risk of a dispenser magazine becoming almost empty and the actual stock level is lower than the total demand for objects for all the input orders, a demand message is emitted. In this respect, the operator can in turn obtain information about the number of objects to be topped up or the time span within which the topping-up operation must be run in order to satisfy all the orders. The latter information might be emitted by means of a warning lamp with different flash frequencies or may be output at a display panel, for example. As a result, the operator receives a sort of priority list, specifying which dispenser magazine must be filled as a priority and which may be topped up “later”. Any stoppage of the system due to a dispenser magazine having been completely emptied can therefore be ruled out.

Advantageous output options for emitting the demand message are described in claim 25.

As a result of the features defined in claims 26 to 30, the distance for determining the level in the dispenser magazines can be detected in a different way.

Advantageous features are also described in claims 31 and 32, whereby the level of all the dispenser magazines can be determined and the operator is immediately aware which dispenser magazines need to be filled as a matter of urgency, optionally independently of the orders. The topping-up operation of those dispenser magazines containing only a small number of objects can be run before starting up the system. If orders have already been detected in the computer system, a counter-check can also already be run to ascertain whether the day's demand can be met by the objects available in the dispenser magazines. If the day's requirements are covered, the operator is available to carry out other work. The task of resources planning can be handed over to an operator.

Finally, the feature defined in claim 33 is also of advantage, since it offers different options for sorting the consignments.

The invention will be described in more detail below with reference to examples of embodiments illustrated in the appended drawings.

Of these:

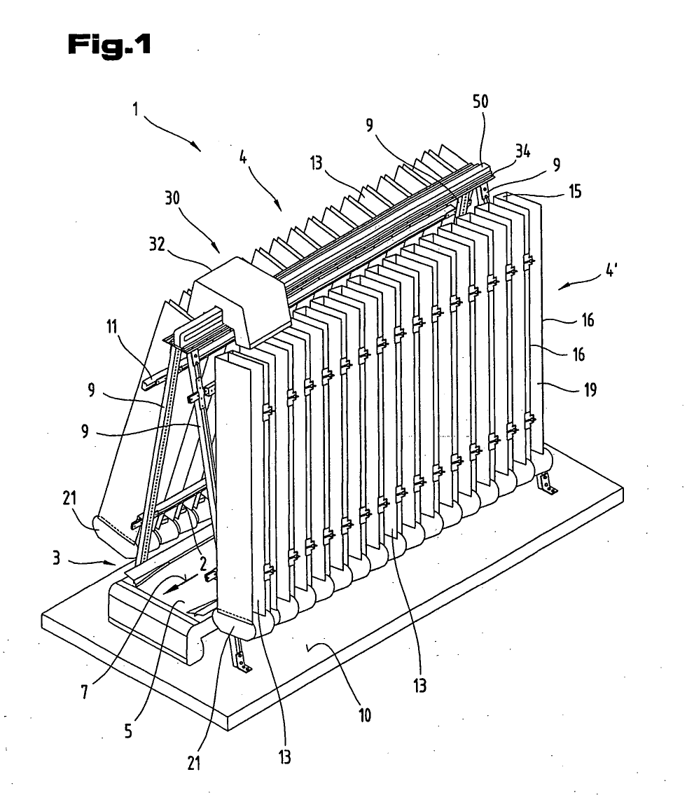

FIG. 1 is a highly simplified diagram showing a perspective view of a system proposed by the invention for dispensing stackable objects, with storage units disposed on either side of a conveyor system and a detection system;

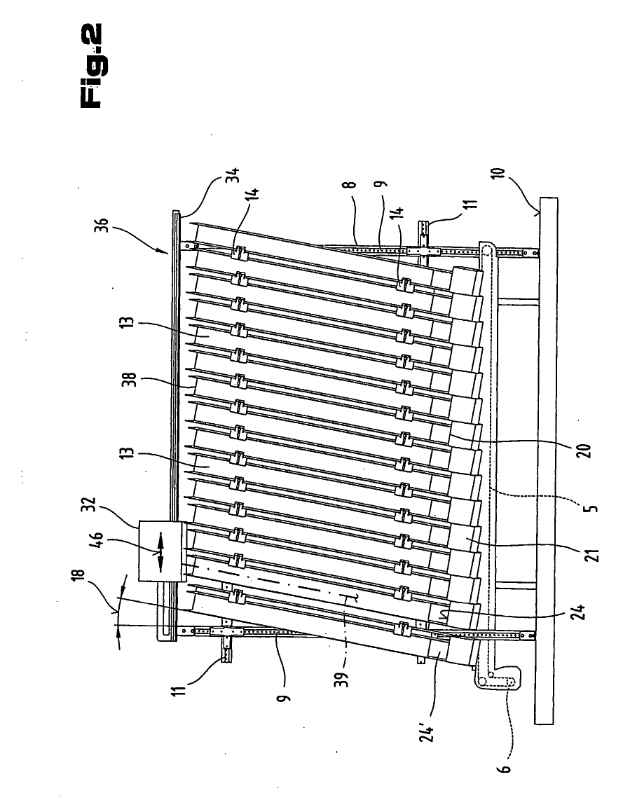

FIG. 2 is a highly simplified diagram showing a side view of the system illustrated in FIG. 1;

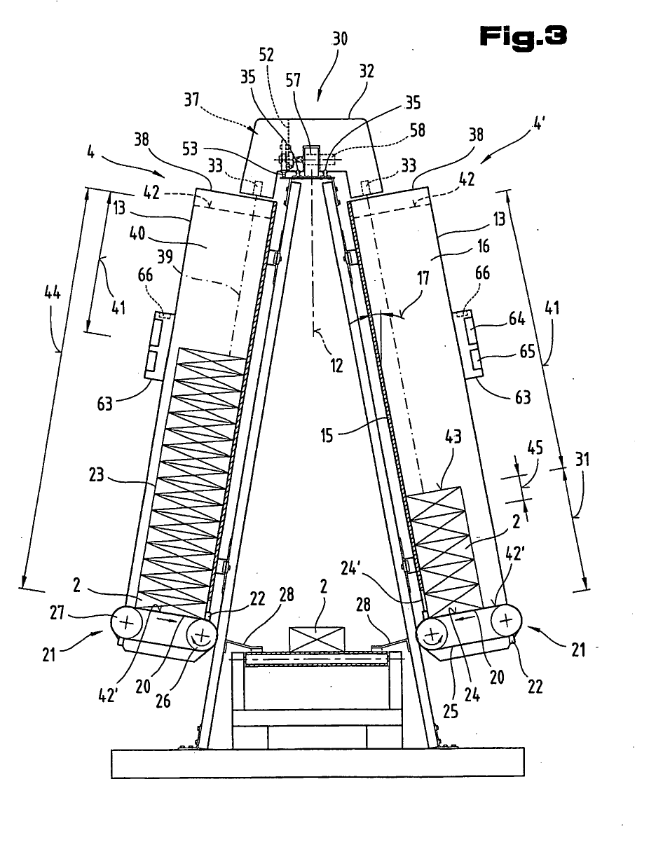

FIG. 3 is a highly simplified diagram showing a section through the system illustrated in FIG. 1, with the oppositely lying dispenser magazines, the discharge system, the conveyor system and the detection system;

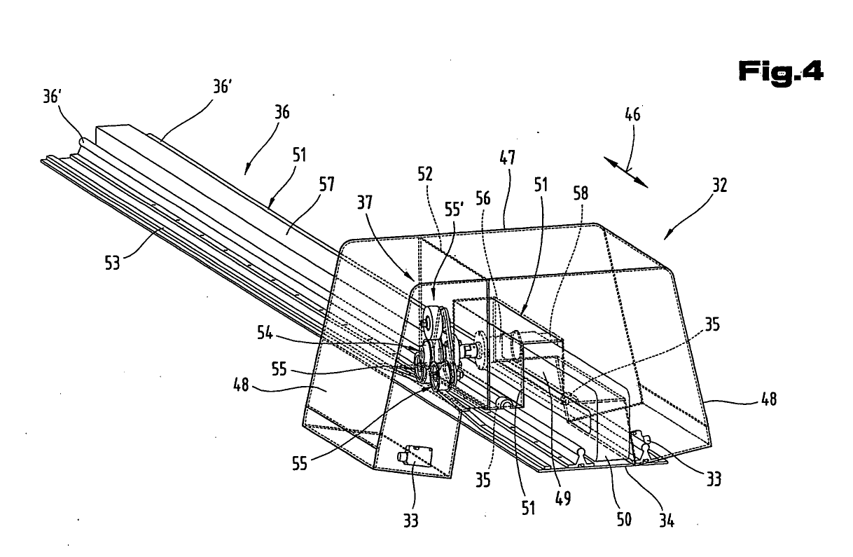

FIG. 4 is a diagram on an enlarged scale showing a control carriage of the detection system which can be displaced along a guide track, with a first embodiment of its drive system, in a perspective view with a highly simplified depiction showing the front wall removed from the control carriage;

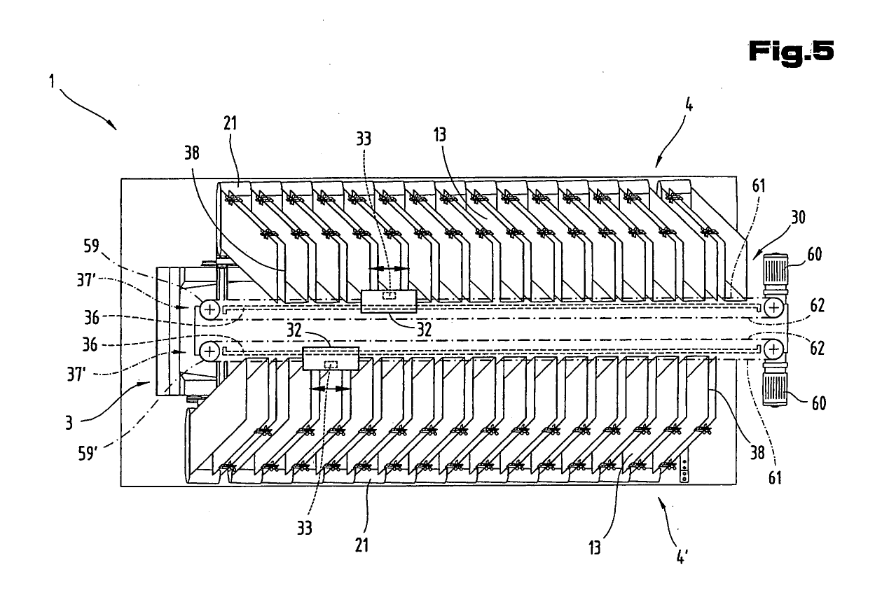

FIG. 5 is a highly simplified, schematic diagram illustrating a plan view of another embodiment of the detection system with two control carriages which can be activated separately from one another and a different embodiment of the drive systems for the control carriage as well as the storage units.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc, relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIGS. 1 to 4, which will be described together, illustrate different views of a computer-controlled system 1 for dispensing stackable objects 2 in shaft-type dispenser magazines of storage units and for monitoring the levels in the dispenser magazines by means of a detection system. In order to keep the drawings clear, the objects 2 are illustrated in FIG. 3 only. The system 1 has storage units 4, 4′ disposed on either side of a conveyor system 3, in particular a horizontal conveyor such as a belt conveyor, for example, and forms a consignment system. A conveyor element 5, in particular a conveyor belt, is coupled with a drive 6 and is driven, preferably uninterrupted, at a constant speed in the conveying direction—indicated by arrow 7. Disposed at the discharge end of the first conveyor system 3 is a transversely extending, second conveyor system (not illustrated) by means of which the consignment objects grouped into orders are fed in transport containers.

The system 1 is supported by means of a support frame 8, in particular struts 9, on a horizontal standing surface 10. The support frame 8 of the system 1 is formed by struts 9 disposed transversely to the conveying direction—indicated by arrow 7—in oppositely lying pairs and inclined towards one another from the bottom to the top, and longitudinal members 11 connecting them.

Lying opposite one another by reference to a vertical plane of symmetry 12 of the system 1, the storage units 4, 4′ each have shaft-type elongate dispenser magazines 13 disposed in their longitudinal extension and along the conveyor system 3 aligned one after the other in a row, each of which is formed by an approximately U-shaped guide section. These dispenser magazines 13 are connected to one another by fixing clamps 14. The storage units 4, 4′ respectively extend across a part-length of the conveyor system 3 and are preferably of the same length. The individual dispenser magazines 13 of the storage units 4, 4′ are inclined both towards the conveyor belt of the belt conveyor and in the longitudinal direction of the belt conveyor so that the objects 2 to be sorted into consignments lie on a base 15 and on at least some regions of one of the parallel legs 16 of the guide section projecting out vertically from the base 15. The inclination of the guide sections towards the center of the conveyor belt is highlighted by the angle of inclination 17 deviating from the vertical direction (see FIG. 3) and the inclination in the conveying direction—indicated by arrow 7—of the conveyor belt, and by the angle of inclination 18 (see FIG. 2) deviating from the vertical direction. Naturally, the dispenser magazines 13 and the guide sections may also inclined only in the direction towards the conveyor belt of the belt conveyor, although the twofold inclination based on the angles of inclination 17, 18 represents the preferred embodiment.

As may be seen from the drawings, a slot-type object top-up opening 19 extends between the parallel legs 16 across the entire length of the dispenser magazine 13, by means of which the dispenser magazines 13 can be manually filled with objects 2. The objects 2 to be sorted into consignments, of a preferably cubic shape, are thus stacked one on top of the other. The dispenser magazines 13 extend just high enough to enable an operator, not illustrated, to reach the uppermost top-up position in the dispenser magazine 13 easily. The objects to be sorted into consignments 2 are introduced into the shaft-type dispenser magazines 13 by hand and form a stack under their own weight.

As illustrated in more detail in FIG. 3, a discharge mechanism 21 controlled by the computer system is disposed in the region of the bottom ends 20 of each dispenser magazine 13. Each discharge mechanism 21 is mounted on the support frame 8 and has at least one driver 22 which can be displaced transversely to the longitudinal extension of the conveyor system 3, by means of which the respective lowermost object 2 can be discharged from the object stack 23 of the respective dispenser magazine 13 onto the conveyor element disposed at a slight distance below a discharge plane 24 formed by the discharge mechanism 21, in particular the top strand of the conveyor belt, or, although this is not illustrated, into a container for the objects to be sorted into consignments, in particular a transport container, fed past the dispenser magazines 13. The object containers specifically provided for the order are conveyed by means of the conveyor system 3.

Each discharge mechanism 21 is provided in the form of a traction drive, for example, comprising at least one endless, flexible traction means 25, such as a belt, chain or similar, circulated by means of a driving gear 26 and guide pulley 27, which is provided with at least one driver 22 and can be driven by a drive motor, in particular an electric motor, in only one direction. The top strand of the traction means 25 constitutes the discharge plane 24. The driving gear 26 is coupled with the drive motor. The drive motor of the discharge mechanisms 21 is connected to a control system of the computer system. In the embodiment illustrated, the driveable traction means 25 is provided with two displaced drivers 22 so that just as one driver 22 has pushed an object 2 out of the dispenser magazine 13, the next driver 22 is either on stand-by or is preventing the next object 2 from slipping out. When the drive motor is switched on, it moves the drivers 22 in the anti-clockwise direction so that the driver 22 disposed at the bottom right-hand side does not act on the object 2 and push it out until it has traveled approximately half a revolution. As it is pushed out, the object 2 is firstly guided along the discharge plane 24 through a discharge orifice 24′ and after leaving it, along a guide plate 28 until a front edge of the object 2 lies on the conveyor element 5 or conveyor belt. The guide plates 28 are disposed on both sides of the conveyor system 3 and parallel with its longitudinal extension and are secured to the struts 9. The discharge direction—indicated by the arrow—extends transversely to the longitudinal extension of the conveyor system 3.

In another embodiment, although this is not illustrated, the displaceable driver 22 is disposed on a pressurized cylinder, such as a pneumatic or hydraulic cylinder and similar.

The system 1 additionally comprises a detection system 30 for determining the levels 31 of objects 2 in the dispenser magazines 13 of the storage units 4, 4′, as schematically indicated in the drawings. For the purpose of the invention, this detection system 30 has a computer-controlled control carriage 32 and, in this embodiment, preferably two measuring units 33 disposed o the control carriage 32, which are connected to a control system of the computer system, one each being assigned to a storage unit 4, 4′. Disposed between the control carriage 32 and a support member 34 of the support frame 8 is a guide mechanism, such as a sliding or roller guide, formed by a guide arrangement 35 disposed on the control carriage 32 and a guide track 36 mounted on the support member 34. The control carriage 32 is guided and mounted by means of its guide arrangement 35 on a guide track 36 on the support frame 8 of the system 1 and can be displaced essentially horizontally by means of a drive system 37, which will be described in more detail below, along the guide track 36 between the individual dispenser magazines 13. The storage units 4, 4′ are provided on both sides of the guide track 36.

In this embodiment, the guide track 36 is formed by means of two linear guides 36′, which are mounted on the support member 34, preferably releasably. The support member 34 is connected to the struts 9 mutually inclined towards one another in the region of their top ends remote from the standing surface 10 and extend between the pairs of struts 9 disposed at a distance apart from one another. The guide track 36 or the linear guides 36′ constituting them extend parallel at a distance apart from one another and parallel with the longitudinal extension of the conveyor system 3. The linear guides 36′ are provided in the form of profiled rails, dovetail guides, flat guides, prismatic guides and similar, for example, whilst the guide arrangements 35 disposed on the control carriage 32 may be provided inn the form of slide guides or roller guides complementing the linear guides 36′.

The measuring units 33 on the control carriage 32 are disposed on both sides of the guide track 36 extending in the direction of the conveyor system 3 and at a slight distance directly above the top ends 38 of the dispenser magazines 13 of the storage units 4, 4′ aligned one after the other in a row. Accordingly, every measuring unit 33 is transversely offset from the guide track 36 and transversely offset from the longitudinal extension of the storage units 4, 4′ in the direction of the respective storage unit 4, 4′ and oriented so that a scanning beam 39 emitted by the measuring unit 33 or an emitted scanning wave extends essentially perpendicular to the discharge plane 24 of the discharge mechanism 21. When the control carriage 32 moves into a measuring position directly above a filling space 40 bounded by the U-shaped guide section, the scanning beam 39 or scanning wave of the measuring unit 33 then extends inside the filling space 40 and hits the uppermost object 2 of the object stack 23.

This being the case, a distance 41 between a top level limit 42 and a flat surface 43 of the respective object 21 lying farthest away from the discharge mechanism 21 is detected by sensors by means of the measuring unit 33, independently of the orders entered in the computer system, in only some of the dispenser magazines 13 of the storage units 4, 4′, and optionally in each dispenser magazine 13 of the storage units 4, 4′. Once the distance 41 has been detected, the level 31 for the relevant dispenser magazines 13 and the actual stock level of objects 2 in the relevant magazines 13 can be calculated by means of the computer system of the warehouse management system. The level 31 is calculated on the basis of the difference between a maximum filled level 44 predetermined by the length of the dispenser magazines 13 and the distance 41. Accordingly, the maximum filled level 44 is bounded by the top level limit 42, predetermined by the terminal upper end 38 of each dispenser magazine 13, and a bottom level limit 42′, predetermined by the terminal bottom end 20 of each dispenser magazine 13. It is preferable if only one type of object 2 is accommodated in each dispenser magazine 13, the individual dimension 45 of which in each case is electronically detected in at least the stacking direction in the computer system, and once the level 31 has been determined, the number of objects 2 in each dispenser magazine 13 or the actual stock level of objects 2 in each dispenser magazine 13 is calculated.

The fact that the measuring units 33 are mounted on the support frame 8 so that they can be displaced jointly by the control carriage 32 relative to the dispenser magazines 13 of the storage units 4, 4′ offers a simple way of enabling the level 31 or levels 31 to be determined sequentially in only one dispenser magazine 13 or in several dispenser magazines 13 disposed one after the other in the displacement direction—indicated by arrow 46—of the control carriages 31 during the movement of the control carriage 32 in the longitudinal direction of the storage unit 4, 4′, as will be explained in more detail below.

FIG. 4 is a diagram on a larger scale illustrating the positioning of the displaceable control carriage 32 which, as briefly described above, can be displaced essentially horizontally along the guide track 36 by means of the drive system 37 and has a frame housing 47. In order to provide a clearer view of the drive system 37, a front wall of the frame housing 47 has been removed. The frame housing 47 is provided in the form of a bent sheet metal construction with the guide arrangements 35 described above, disposed on the bottom face directed towards the linear guides 36′, and has housing parts 48 on either side of the guide arrangements 35 projecting out from the bottom face of the frame housing 47 respectively in the direction of the storage units 4, 4′, on which the measuring units 33 are mounted. As also illustrated, the frame housing 47 also has a housing duct 49 between the housing parts 48 extending from the bottom face in the direction of the top face for a for a power and signal transmission system 50 and a supporting 52 wall extending between the bottom and top faces parallel with the internal walls 51. The housing duct 49 is laterally bounded by the internal walls 51. Front walls are secured to the frame housing 47 at front ends.

In this embodiment, the drive system 37 for the control carriage 32 is provided in the form of a finite traction means 53, in particular a cogged belt, chain and similar, the two free ends of which are secured to the support frame 8, in particular the support member 34. The traction means 53 is guided by a driving gear 54, in particular a toothed gear, and turned by means of wheels 55 disposed on either side of it. As indicated, a pressing wheel 55′ may be provided for the traction means 53 at higher displacement speeds of the control carriage 32—approximately in the range of 0.2 n/s to 0.3 m/s. The driving gear 54, the wheels 55 and the pressing wheel 55′ are disposed axially parallel with one another and are mounted on the frame housing 47, in particular on the supporting wall 52, so as to be rotatable, and the driving gear 54 is coupled with a drive motor 56, such as an electric, pneumatic, hydraulic or hybrid motor and similar, optionally with a coupling connected in between, as indicated. The drive motor 56 is likewise mounted on the frame housing 47, in particular on an internal wall 51. A drive system 37 of this type is generally known as an omega drive. Other embodiments of the drive system 37 for the control carriage 32 will be described later.

As may also be seen from this drawing, the system 1 has the power and signal transmission system 50, by means of which the control carriage 32 is connected to the computer system and the drive motor 56 is supplied with electrical or mechanical energy, and signals/data are transmitted between the computer system and the drive motor 56. In this embodiment, the power and signal transmission system 50 is provided in the form of a plurality of electric cables or lines conveying pressurizing medium and/or a bus line of a bus system, such as a profi-bus system and similar, for example. The cables and/or the bus line are moved with the control carriage 32 when it moves and a power chain 57 of a known type is therefore provided as a means of guiding it. The drive motor 56 is connected to the control system of the computer system of the warehouse management system via an electric signaling cable or the bus system. The computer system controls the drive motor 56. To this end, the computer system comprises the control system and a computer connected to it (personal computer).

Although not illustrated, a loop line arrangement of a type known per se may alternatively be used for the power and signal transmission system 50, comprising loop lines mounted on the support frame 8, in particular on the support member 34, in a stationary arrangement and sliding contacts mounted on the control carriage 32. This being the case, the drive motor 56 can be supplied with electrical energy and electrical control signals by means of the loop lines, which can be drawn from the loop lines by means of the sliding contacts.

In another embodiment of the power and signal transmission system 50, although this is not illustrated, it may be constituted by the traction strands provided in the traction means 53 anyway and made from aramide or glass fiber or steel cord, in other words materials which are electrically conductive, and the power is supplied and control signals transmitted via the traction strands of the traction means 53 between the drive motor 56 and the control system connected to the computer system. To this end, the traction strands are connected via electric cables to the drive motor 56 and control system.

Finally, however, it would also be possible for the power and signal transmission system 50 to be provided in the form of a transmitter and receiver unit on the control carriage 32 and a transmitter and receiver unit on the control system of the computer system, although this is not illustrated, so that the electrical energy and/or electric control signals and/or data signals are transmitted wirelessly between the control carriage 32 and the computer system, which is likewise provided with the transmitter and receiver unit. The drive motor 56 receives its control signals via a transmitter and receiver unit, likewise disposed on the control carriage 32, which is connected to the control system by means of an optical data transmission system, for example, in particular an infrared data transmission system or laser data transmission system. This also enables a contactless signal and/or data transmission between the control system and the drive motor 56 and/or a contactless power supply for the electric drive motor 56 using electromagnetic and/or inductive means, such as radio, e.g. Bluetooth™, WLAN (Wireless Local Area Network), eddy fields.

The two measuring units 33 may also be connected to the control system by means of the power and signal transmission system 50 described above and supplied with electrical power by contacting means, such as the cables and/or bus line, loop cable arrangement or traction strands of the traction means 53, which are connected to the control system of the computer system and the measuring units 33, or contactlessy by means of electromagnetic, optical or inductive systems.

In another embodiment, the measuring units 33 are respectively equipped with a transmitter and receiver unit, not illustrated, in which case the power supply to the respective measuring unit 33 is effected wirelessly via the receiver unit and the electric measurement signals produced when measuring the distance 41 for determining the level 31 in the relevant dispenser magazine 13 are transmitted by means of the transmitter unit either to the control system connected to the computer system or to a control unit connected to the computer system, which will be described in more detail below.

The measuring units 33 constitute distance measuring systems and are provided in the form of an optoelectronic measuring system, in particular a laser or infrared measuring system or triangulation sensor and similar, for example, or in the form of an ultrasound sensor, by means of which the distance 41 can be measured without any difficulty up to an amount of approximately 2.5 m and the level 31 in the respective dispenser magazines 13 can be reliably determined. If dispenser magazines 13 with a lower filled level 44 are used, it would also be conceivable for the measuring units 33 to be provided in the form of capacitive sensors, in which case a scanning field of the measuring units 33 is oriented substantially parallel with the longitudinal extension of the dispenser magazines 13 and substantially perpendicular to the discharge plane 24 of the discharge mechanisms 21.

As explained in connection with FIG. 1, the control carriage 32 must approach the measuring positions and these must be exactly assigned to each of the dispenser magazines 13 to enable the relevant levels 31 to be determined for each of the dispenser magazines 13. In this situation, it is assumed that the control carriage 32 will travel in a pendulum motion uninterrupted between the first dispenser magazine 13 in the displacement direction—indicated by arrow 46—and the last dispenser magazine 13 of the storage unit 4, 4′, and the levels 31 in each dispenser magazine 13 are detected in sequence. As viewed on the basis of the displacement path of the control carriage 32, the number of measuring positions which must be approached corresponds exactly to the number of dispenser magazines 13 which a storage unit 4, 4′ has, and the term measuring position should be understood as meaning that the measuring unit 33 is positioned approximately at the center between the legs 16 and above the filling space 40 of a dispenser magazine 13.

To enable a measuring position approached by the control carriage 32 to be correlated with a dispenser magazine 13 in this way, a positioning system 58 is provided as a means of positioning the control carriages 32 relative to the individual dispenser magazines 13 of the storage unit 4, 4′. Accordingly, the detected actual position of the control carriage 32 is constantly transmitted to the control system of the computer system. The control system compares the actual position with the measurement positions pre-defined by the computer system and assigned to the dispenser magazines 13, and if the actual position matches one of the respective measuring positions, the distance 41 is measured and transmitted to the control system as an electric measurement signal, after which the level 31 or actual stock level of objects 4 in the respective dispenser magazine 13 is determined in the manner described above.

Alternatively, another option is one whereby the levels 31 only have to be determined in individual dispenser magazines 13 used for an order entered in the computer system. In this situation, the control carriage 32 approaches only those measurement positions at which objects 2 to be sorted into consignments are held for this order. Each measurement position is disposed directly above each dispenser magazine 13. From these measurement positions, the distance 41 for determining the levels 31 is then measured. In order to approach these measurement positions in the correct position, the drive motor 56 is activated accordingly by the computer system and the actual position is constantly transmitted from the control carriage 32 to the computer system.

In both variants, the distance 41 is measured as soon as the measurement position is reached. During the measurement, the control carriage 32 mar briefly remain in the measurement position or may move at a reduced speed or may move at normal speed.

The positioning system 58 for controlling the position of the control carriage 32 is preferably provided in the form of a distance measuring system connected to the control system, by means of which the actual position of the control carriage 32 or a relative position of the control carriage 32 with respect to the individual dispenser magazines 13 is detected by sensors. The distance measuring system is set up on the basis of capacitive distance recorders, inductive distance recorders, magnetic distance recorders or optoelectronic distance recorders of a type known per se. Accordingly, the measurement method is based on absolute and incremental distance measurements.

In the embodiment illustrated, the drive motor 56 is provided with a resolver or incremental counter as a positioning system 58, by means of which the actual position of the control carriage 32 is detected on a permanent basis. Since a permanent comparison is run between the actual position and the desired positions which correspond to the measurement positions to be approached, the control carriage 32 can be activated on an automatic basis.

Alternatively, the positioning system 58 may be provided in the form of a bar code positioning system, although this is not illustrated, in which case a bar code label may be attached to the support frame 8 of the system 1 across the entire length of the displacement path of the control carriage 32 and the actual position of the control carriage 32 relative to the bar code strip and the support frame 8 is determined by means of a bar code reader disposed on the control carriage 32 using an optical measuring method, in particular by means of a visible red light laser. The detected actual position or the actual positions value is transmitted to the control system.

If mechanical stress is low, it would also be conceivable to provide proximity sensors or mechanically acting limit switches along the displacement path of the control carriage 32, each of which co-operates with a dispenser magazine 13, by means of which the measurement positions above each dispenser magazine 13 can be exactly approached. The displacement path of the control carriage 32 extends across the entire longitudinal extension of the storage units 4, 4′.

Although this is not illustrated, another option is for the positioning system 58 to be provided in the form of a position locating system, in particular a navigation unit in the form of GPS for detecting the actual position of the control carriage 32 relative to each individual dispenser magazine 13. To this end, the control carriage 32 is provided with a transmitter and/or receiver unit on the one hand, and the control system is provided with a transmitter and/or receiver unit on the other hand, across which a wireless data exchange takes place.

FIG. 5 is a highly simplified schematic diagram illustrating another possible embodiment of the detection system 30 with two control carriages 32 and the drive systems 37′ co-operating with them. The drive systems 37′ each comprise an endlessly circulating traction drive 59, 59′, each of which is coupled with a drive motor 60, such as an electric, pneumatic, hydraulic or hybrid motor and similar. The drive motors 60 are connected to the control system. The control carriages 32 are each connected to a strand 61 of the traction means 62 so that they are unable to move. The drive motors 60 of the two traction drives 59, 59′ can either be controlled separately from one another, in which case the control carriages 32 are displaced independently of one another, or are synchronized, in which case the control carriages 32 can optionally also be displaced synchronously. The actual positions of the control carriages 32 are constantly detected by means of resolvers provided on the drive motors 60 for example, operating as a distance measuring system. If the storage units 4, 4′ are of longer lengths, it is expedient for the control carriages 32 to be displaceably guided in each case along a guide track 36 indicated by broken lines, in particular a linear guide. The guide tracks 36 extend parallel at a distance from one another and in the longitudinal direction of the storage units 4, 4′. Each control carriage 32 is in turn provided with at least one measuring unit 33 of the type described above. The control carriages 32 are respectively disposed above the top ends 38 of the dispenser magazines 13 of each storage unit 4, 4′ and can be displaced and positioned by means of the respective traction drives 59, 59′ between the individual dispenser magazines 13. The measuring units 33 detect in sequence the distance 41 in at least some of the dispenser magazines 13 of the storage units 4, 4′ disposed one after the other in the displacement direction—indicated by arrow 46—of the control carriages 32, and the level 31 in the relevant dispenser magazines 13 is determined.

Although not illustrated, the drive system 37, 37′ for the control carriage 32 is provided in the form of a toothed gear-toothed rack drive in another embodiment. The toothed rack is mounted on the support frame 8 and the gear meshing with it is mounted on the control carriage 32, which is coupled with a drive motor. It would also be conceivable to drive the control carriages 32 by a system based on friction.

Although not illustrated, the drive system 37, 37′ for the control carriage 32 may likewise be provided in the form of a linear motor, in particular an asynchronous and synchronous linear motor, of a type known from the prior art. Linear motors enable a linear motion to be generated directly without a gear system. The comprise a primary part to which current is applied (comparable to the stator of a rotary motor) and a reacting part or secondary part (comparable with the rotor of a rotary motor). The primary part is expediently mounted on the support frame 8, in particular on the support member 34, whilst the secondary part is disposed on the control carriage 32 which is guided in displacement essentially with no play along a guide track 36, as described above. The stationary primary part extends continuously across the entire length of the displacement path of the control carriage 32. In order to drive the control carriages 32 without contact, one option is to use a long-stator synchronous motor. This being the case, the driving power is delivered to the primary part disposed in the displacement path, whilst the control carriage 32 contains only an exciter component. The exciter component is disposed so that the control carriage 32 is carried by magnetic field forces. Again with this embodiment, a positioning system, in particular a distance measuring system, is provided between the control carriage 32 and the support frame 8, which is connected to the control system via the power and signal transmission system 50 described above.

Naturally, any other drive systems 37, 37′ known from the prior art which will generate a linear drive for the control carriages 32 may be used.

Each dispenser magazine 13 of the storage units 4, 4′ is provided with at least one control unit 63, although this is illustrated in FIG. 3 only, in order to ensure greater clarity in the drawings. It has an input device 64 and/or an acoustic and/or optical output device 65 and optionally a transmitter and receiver unit 66 as indicated by broken lies, for wirelessly transmitting data and/or signals between the control system of the computer system and the control unit 63 and/or the relevant measuring unit 33 and the control unit 63. The control unit 63 is connected via an electric cable, preferably a bus system or optical data transmission system, for example an infrared data transmission system or laser data transmission system, to the control system.

The input device 64 is a keyboard, touch-screen or a voice recognition system, for example. The output device 65 comprises an optical and/or acoustic output element, for example in the form of a warming lamp or display panel, which indicates whether there is a sufficient supply of objects 2 in the relevant dispenser magazine 13, or whether there is a risk of these objects 2 running out whilst processing the orders entered in the computer system, in which case it will be necessary to top up the objects 2. The output device 65 may also have a speech output module and/or a numerical and/or alphanumerical display, for example in the form of a monitor or an LED display, on which the current level 31 or the demand for more objects 2 calculated on the basis of the order(s) entered in the computer system and/or predicted sales quantity and the quantity needed to top up the dispenser magazines 13 is output. The input device 64 and output device 65 may naturally also be combined in one unit in the form of a touch-screen. The control unit 63 is preferably mounted directly on the relevant dispenser magazine 13.

Alternatively, the control unit 63 may also be provided in the form of a mobile hand-held device equipped with a transmitter and receiver unit 66, which is connected to the control system and/or the measuring units 33 by means of an optical signal and data transmission system, in particular an infrared data transmission system or laser data transmission system. It would also be possible to operate a wireless transmission of data and/or signals across a radio connection between the control unit 63 and/or control system and/or the measuring units 33. To this end, the control system and/or the measuring units 33 are likewise equipped with a transmitter and receiver unit.

Although not illustrated, in another embodiment of the system 1 for dispensing stackable objects 2, it comprises exclusively one storage unit 4 with the shaft-type, elongate dispenser magazines 13 disposed in its longitudinal direction aligned in a row one after the other, incorporating the discharge mechanisms 21 disposed at the bottom end 20 of each dispenser magazine 13 as well as the detection system 30. The detection system 30 has at least one control carriage 32 disposed above the top ends 38 of the dispenser magazines 13 which can be displaced and positioned by means of the drive systems 37, 37′ between the individual dispenser magazines 13 in the longitudinal direction of the storage unit 4. The control carriage 32 is guided by means of at least one guide arrangement 35 along the guide track 36, in particular a linear guide 36′, extending in the longitudinal direction of the storage unit 4 and disposed adjacent to the top end 38 of the dispenser magazines 13. Disposed on the control carriage 32 is the at least one measuring unit 33, by means of which the distance 41 between the uppermost object 2 contained in the dispenser magazine 13 and the maximum top level limit 42 of a dispenser magazine 13 is measured in sequence as the control carriages 32 is moved. Using the distance 41, the computer system calculates the level 31 of objects 2 in the respective dispenser magazines 13. The measuring unit 33 is transversely offset from the guide track 36 in the direction of the storage unit 4 and above the top ends 38 of the dispenser magazines 13 of the storage units 4, and is oriented so that a scanning beam 39 emitted by the measuring unit 33 or an emitted scanning wave extends essentially perpendicular to the discharge plane 24 of the discharge mechanism 21. The system 1 used in this embodiment is an automatic vending machine, whereby the desired object 2 is dispensed through a discharge orifice directly to the consumer. The dispenser magazines 13 are oriented in a perpendicular arrangement in this embodiment, for example.

A description will now be given of the method of dispensing stackable objects 2 used with the system 1 described above. It is assumed that the objects 2 are to be introduced into the dispenser magazines 13 one type in each, so that each dispenser magazine 13 contains only one sort or type of object 2. In principle, there are two different ways of sorting objects 2 into consignments. Firstly, object holders, in particular transport containers are conveyed along the conveyor system 3. To this end, these object holders are provided with a code assigned to an order which is entered in the computer system. The code comprises an identification number, by means of which the object holder can be unambiguously allocated to an order. The object holders are transported along the conveyor system 3 and fed past a plurality of dispenser magazines 13 disposed at each side of the conveyor system 3, and as they are fed past, the dispenser magazines 13 are filled with the allocated objects 2 bearing the respective code. Depending on the allocation of the code of an object holder, the discharge mechanisms 21 are activated by the computer system and the individual objects 2 are transferred to the transport containers.

With the second option, the objects to be sorted into consignments 2 are deposited directly on the conveyor element 5 of the conveyor system 3 according to the entered orders. To this end, as the conveyor element 5 is being fed underneath the dispenser magazines 13, the discharge mechanisms 21 by means of which the objects to be sorted into consignments 2 and discharged from the dispenser magazines 13 are activated. The discharged objects 2 are sorted into groups relating to an order on the conveyor element 5. Disposed at the discharge end of the first conveyor system 3 is a second conveyor system (not illustrated) for transporting the objects 2 sorted into consignment groups relating to a specific order in object holders. The objects 2 relating to an order are accommodated in an object holder.

In order to avoid having to stop the system 1, as would happen if an object 2 were needed from a dispenser magazine 13 that was empty and at least one order entered in the computer system could therefore not be fulfilled, care must be taken to ensure that at least those dispenser magazines 13 containing the objects 2 needed for an order are sufficiently filled.

For the purpose of the invention, the distance 41 between the uppermost object 2 and the maximum top level limit 42 are detected, having set up at least one order, or a predicted sales quantity of objects 2 in one or more dispenser magazines 13 is detected and the level 44 or actual stock level of objects 2 in one or more dispenser magazines 13 is determined.

If an order based on only one type of (identical) object 2 is electronically entered in the computer system, the computer system will therefore calculate the number of objects 2 needed on the basis of a desired stock level corresponding to this order for those dispenser magazines 13 in which the objects 2 allocated to the order will be dispensed. The measuring unit 33 then contactlessly detects the distance 41 in the manner described above and from it, the level 31 is calculated as well as the actual stock level of objects 2 in this dispenser magazine 13 taking account of the dimensions 45 of the objects 2 stacked one above the other in the stacking direction. This calculation is run by the computer system, in particular the control system. The actual stock level of objects 2 is then compared with the desired stock level of objects 2 calculated for the dispenser magazine 13 based on the order. If the actual stock level of objects 2 is lower than the desired stock level of objects 2 needed to process the order correctly and/or if there will shortly be a drop below the desired stock level of objects 2, a demand message is issued to the operator at the computer system, in particular a computer (PC), and/or at the output device 65 of the control unit 63, prompting the operator to fill this dispenser magazine 13. The demand message may be output by means of a voice message or optically or acoustically, for example by means of a warning lamp, text or numerical display or a signal horn.

If the order entered comprises several different objects 2, the desired stock level of objects 2 corresponding to the entered order is calculated by the computer system for those dispenser magazines 13 from which the different objects 2 are to be dispensed. For example, the first type of object 2 is to be dispensed from the first dispenser magazine 13 and the second type of object 2 is to be dispensed from the second dispenser magazine 13 and so on. The measuring unit 33 then contactlessly detects the distance 41, in sequence, in these relevant dispenser magazines 13 and each current level 31, and taking account of the dimensions 45 of the objects 2 stacked one on top of the other in the stacking direction, the actual stock level of objects 2 in these relevant dispenser magazines 13 is determined. A comparison is then run between the actual stock levels of objects 2 in the relevant dispenser magazines 13 and the desired stock level calculated for these relevant dispenser magazines 13. A demand message prompting the operator to top up one or more dispenser magazines 13 is then issued if the actual stock level of objects 2 in one of the dispenser magazines 13 is lower than the desired stock level of the different objects 2 needed to make up the order and/or will soon be lower than it.

When a second, third order, etc., is entered in the computer system after the first order, the computer system firstly determines a desired stock level of the same or different objects 2 in a dispenser magazine 13 or several dispenser magazines 13 needed to meet all of the orders. If the order is made up of only one type of object 2, the distance 41 between the uppermost object 2 and the top level limit 42 in this one dispenser magazine 13 is measured, whereas if the order is made up of different types of objects 2, the distance 41 between the uppermost objects 2 and the maximum, top level limit 42 is measured in sequence in those dispenser magazines 13 from which the different objects 2 are to be dispensed. Accordingly, the current level 31 and the actual stock level of objects 2 is calculated by the computer system only for one dispenser magazine 13 or several dispenser magazines 13. This is followed by the comparison between the actual stock level of objects 2 in the one relevant dispenser magazine 13 or in the relevant dispenser magazines 13 and the desired stock level for this one relevant dispenser magazine 13 or the relevant dispenser magazines 13. A demand message for a dispenser magazines 13 is output at the computer system and/or at the control unit 63 if the actual stock level of objects 2 in the relevant dispenser magazine 13 or in one of the relevant dispenser magazines 13 falls short of the desired stock level of the objects 2 needed for all the orders entered or will soon fall short of it.

Optimum delegation of resources planning to operators can be achieved if a predicted sales quantity of at least one type of object 2 is electronically detected in the computer system within a set time window, for example a day, a week. The predicted sales quantity is derived from values based on experience or statistical evaluations. The entry made in the computer system is a quantitative amount. For example, let us assume that 100 items of an object 2 were needed in one week. Using the predicted sales quantity, the desired stock level of objects 2 needed in a specific dispenser magazine 3 is determined by the computer system, in this case 100 objects 2. The measuring unit 33 then detects the distance 41 without contact in the manner described above and from it, the level 31 and, taking account of the dimensions 45 of the objects 2 stacked one on top of the other in the stacking direction, the actual stock level of objects 2 in this dispenser magazine 13 is calculated. A comparison is then run between the actual stock levels of objects 2 in this relevant dispenser magazine 13 and the desired stock level calculated for this dispenser magazine 13 from the predicted sales quantity. If there is a drop below the desired stock level calculated for the predicted sales quantity or there will shortly be a drop below it, a demand message is issued to the operator and the relevant dispenser magazine 13 must be topped up.

If a predicted sales quantity for several different objects 2 is entered in the computer system for a set time window, a desired stock level of different objects 2 in the relevant dispenser magazines 13 corresponding to the predicted sales quantity is calculated by the computer system. Then, the respective distance 41 in these relevant dispenser magazines 13 is measured without contact and each actual stock level of objects 2 in these relevant dispenser magazines 13 is calculated by the computer system. Once the actual stock level of objects 2 in these relevant dispenser magazines 13 has been compared with the desired stock level needed for these relevant dispenser magazines 13, a demand message is issued to the operator to top up a dispenser magazine 13 if the actual stock level of objects 2 falls short of the desired stock level of the predicted sales quantity of different objects 2 needed and/or will shortly fall short of it.

At this stage, it should be pointed out that orders are entered and predicted sales quantities of objects 2 are entered in a computer (personal computer) of the computer system by means of an input device, such as a keyboard, touch-screen, voice input and similar.

Finally, after having been topped up, the actual stock level of objects 2 in this one filled dispenser magazine 13 or in the relevant filled dispenser magazines 13 is determined again on the basis of the distance 41 detected by the measuring unit 33 and the demand message reactivated when the actual stock level of objects 2 falls short of the desired stock level of objects 2 again. This obviates the need for confirmation keys for confirming a top-up operation on the control unit 63.

The distance 41 for determining the levels 31 in one dispenser magazine 13 or several dispenser magazines 13 may be detected by means of the control carriage 32 described above, fitted with the measuring units 33 or by means of measuring units (not illustrated), which are stationary, mounted on each dispenser magazine 13. In the case of the latter embodiment, the measuring unit 33 is mounted at the top end 38 at a slight distance above the maximum, top level limit 42 of each dispenser magazine 13. These measuring units are in turn provided in the form of optoelectronic measuring systems, such as laser or infrared measuring systems, or ultrasound sensors, and a scanning beam or a scanning wave of the measuring unit 33 extends substantially parallel with the longitudinal extension of the dispenser magazines 13 and substantially perpendicular to the discharge plane 24 of the discharge mechanism 21.

As described above, the distance 41 is measured only at that dispenser magazine 13 or those dispenser magazines 13 needed for the objects 2 for the order (orders) entered in the computer system or the predicted sales quantity of objects 2 entered in the computer system.

Alternatively, however, it would also be possible for the distance 41 between the uppermost object 2 and the maximum, top level limit 42 in each dispenser magazine 13 of the storage units 4, 4′ to be detected and the associated levels 31 determined. To this end, the distance 41 in the dispenser magazines 13 of the storage unit 4, 4′ is now respectively measured on a constant basis by means of the measuring units 33 and the actual stock level in the dispenser magazines 13 is continuously determined. Alternatively, the distance 41 in the dispenser magazines 13 of the storage unit 4, 4′ may also be detected on an intermittent basis, in which case the current actual stock level in the dispenser magazines 13 is continuously determined at pre-set time intervals.

In another possible embodiment, the distance 41 is detected by means of the measuring units 33 mounted on the control carriage 32, and a measuring unit 33 is assigned to each storage unit 4, 4′. To this end, the control carriage 32 is moved into the measurement position above a dispenser magazines 13 and the distance 41 for determining the actual stock level of this dispenser magazines 13 is measured. If the actual stock level of another dispenser magazine 13 has to be determined, the control carriage 32 is moved into the other measurement position above the other dispenser magazine 13. The control carriage 32 moves only to that dispenser magazine 13 or those dispenser magazines 13 containing objects 2 for a given order or for which a predicted quantity of objects to be sorted into consignments 2 has been entered. In another variant of the activation system, the control carriage 32 is moved continuously backwards and forwards between the first and last dispenser magazine 13 in its displacement direction—indicated by arrow 46—and detects the distance 41 for determining the actual stock levels in a dispenser magazine 13 or in each of the dispenser magazines 13 as it does so.

The embodiments illustrated as examples represent possible design variants of the system 1 and it should be pointed out at this stage that the invention is not specifically limited to the design variants specifically illustrated, and instead the individual design variants may be used in different combinations with one another and these possible variations lie within the reach of the person skilled in this technical field given the disclosed technical teaching. Accordingly, all conceivable design variants which can be obtained by combining individual details of the design variants described and illustrated are possible and fall within the scope of the invention.

For the sake of good order, finally, it should be pointed out that, in order to provide a clearer understanding of the structure of the system 1, it and its constituent parts are illustrated to a certain extent out of scale and/or on an enlarged scale and/or on a reduced scale.

### LIST OF REFERENCE NUMBERS

1 System

2 Object

3 Conveyor system

4 Storage unit

4′ Storage unit

5 Conveyor element

6 Drive

7 Arrow

8 Support frame

9 Strut

10 Standing surface

11 Longitudinal member

12 Plane of symmetry

13 Dispenser magazine

14 Fixing clamps

15 Base

16 Leg

17 Angle of inclination

18 Angle of inclination

19 Object top-up opening

20 Bottom end

21 Discharge mechanism

22 Driver

23 Object stack

24 Discharge plane

24′ Discharge orifice

25 Traction means

26 Driving gear

27 Guide pulley

28 Guide plate

30 Detection system

31 Level

32 Control carriage

33 Measuring unit

34 Support member

35 Guide arrangement

36 Guide track

36′ Linear guide

37 Drive system

37′ Drive system

38 Top end

39 Scanning beam

40 Filling space

41 Distance

42 Level limit

42′ Level limit

43 Surface

44 Filled level

45 Dimension

46 Arrow

47 Frame housing

48 Housing part

49 Housing duct

50 Power and signal transmission system

51 Internal wall

52 Supporting wall

53 Traction means

54 Driving gear

55 Wheel

55′ Pressing wheel

56 Drive motor

57 Power chain

58 Positioning system

59 Traction drive

59′ Traction drive

60 Drive motor

61 Strand

62 Traction means

63 Control unit

64 Input device

65 Output device

66 Transmitter and receiver unit

1-33. (canceled)

34. System (1) for dispensing stackable objects (2) in shaft-type dispenser magazines (13) of at least one storage unit (4) and monitoring the levels (31) in the dispenser magazines (13) by means of a detection system (30), which dispenser magazines (13) are disposed in the longitudinal direction of the storage unit (4) aligned one after the other in a row and each is formed by a guide section against certain regions of which the objects (2) stacked one on top of the other in a dispenser magazine (13) lie, and discharge mechanisms (21) controlled by a computer system are provided at the bottom end (20) of each of the dispenser magazines (13), and the detection system (30) is connected to the computer system, wherein the detection system (30) comprises at least one control carriage (32) disposed above the top end (38) of the dispenser magazines (13) which can be displaced by means of at least one drive system (37; 37′) between the individual dispenser magazines (13) in the longitudinal direction of the storage unit (4) and which is provided with a measuring unit (33) for detecting the distance (41) between the uppermost object (2) lying the farthest away from the discharge mechanism (21) and a maximum, top level limit (42) of a dispenser magazine (13) in order to determine the level (31) of objects (2) in at least one of the dispenser magazines (13).

35. System according to claim 34, wherein the control carriage (32) has at least one guide arrangement (35) by means of which it is guided on a guide track (36) extending in the longitudinal direction of the storage unit (4) and disposed adjacent to the top end (38) of the dispenser magazines (13).

36. System according to claim 35, wherein the guide track (36) is provided in the form of at least one linear guide (36′) and the control carriage (32) is mounted by means of the guide arrangement (35) on the linear guide (36′), and is mounted on a support frame (8) of the system (1) so that it can be displaced by means of the drive system (37; 37′).

37. System according to claim 34, wherein the drive system (37; 37′) is provided in the form of a traction drive, friction gear drive, toothed gear-toothed rack drive or linear drive coupled with a drive motor (56; 60) and the drive motor (56; 60) is connected to a control system of the computer system.

38. System according to claim 34, wherein the measuring unit (33) is provided in the form of a measuring system which detects the distance (41) without contact.

39. System according to claim 38, wherein the measuring unit (33) is provided in the form of an optoelectronic measuring system, in particular a laser or infrared measuring system, and a scanning beam (39) of the measuring unit (33) extends essentially parallel with the longitudinal extension of the dispenser magazines (13) and essentially perpendicular to the discharge plane (24) of the discharge mechanism (21).

40. System according to claim 38, wherein the measuring unit (33) is provided in the form of an ultrasound sensor and ultrasound waves of the measuring unit (33) extend essentially parallel with the longitudinal extension of the dispenser magazines (13) and essentially perpendicular to the discharge plane (24) of the discharge mechanism (21).

41. System according to claim 34, wherein a positioning system (58) is provided for positioning and detecting the actual position of the control carriage (32) relative to the individual dispenser magazines (13).

42. System according to claim 41, wherein the positioning system (58) comprises a distance measuring system or a position locating system for detecting the relative position of the control carriage (32) with respect to the individual dispenser magazines (13).

43. System according to claim 37, wherein the drive motor (56; 60) incorporates the distance measuring system or the distance measuring system is disposed between the control carriage (32) and a support frame (8) of the system (1).

44. System according to claim 42, wherein the position locating system is provided in the form of a navigation system, in particular GPS, comprising a transmitter and/or receiver unit disposed on the control carriage (32) and a transmitter and/or receiver unit disposed in the frame region of the system (1).

45. System according to claim 34, wherein a second storage unit (4′) is disposed lying opposite the first storage unit (4) by reference to a vertical plane of symmetry (12), and the second storage unit (4′) has shaft-type, elongate dispenser magazines (13) disposed in its longitudinal direction aligned one after the other in a row, and a discharge mechanism (21) is provided at the bottom end (20) of each dispenser magazine (13), and a conveyor system (3), in particular a belt conveyor, extends between the two storage units (4, 4′) parallel with their longitudinal direction disposed at a slight distance underneath the bottom end (20) of the dispenser magazines (13) and a discharge direction of each discharge mechanism (21) extends transversely to the longitudinal direction of the conveyor system (3).

46. System according to claim 45, wherein the storage units (4, 4′) are disposed on both sides of the guide track (36), and the guide track (36) extends continuously, adjacent to and parallel with the top end (38) of the oppositely lying dispenser magazines (13) in the longitudinal direction of the storage units (4, 4′) across the entire length of the system (1), and the control carriage (32) is provided with two respective measuring units (33) transversely offset from the guide track (36) in the direction of the storage units (4, 4′) and disposed above the dispenser magazines (13) of the storage units (4, 4′) for detecting the distance (41) in the relevant dispenser magazines (13) of the storage units (4, 4′).

47. System according to claim 45, wherein the dispenser magazines (13) of the storage units (4, 4′) are inclined towards a horizontal conveyor plane of the conveyor system (3) and optionally also in the longitudinal direction of the conveyor system (3).

48. System according to claim 34, wherein the dispenser magazines (13) and the guide track (36) are mounted on a common support frame (8) of the system (1) and the guide section of the dispenser magazines (13) is of a U-shaped design and is open at its terminal ends (20, 38), and a base (15) faces the support frame (8) and parallel legs (16) of the base (15) bound a slot-like object top-up opening (19).

49. System according to claim 34, wherein the at least one measuring unit (33) is connected to a control system of the computer system of a warehouse management system and/or a control unit (63).

50. System according to claim 34, wherein each dispenser magazine (13) is provided with a control unit (63) comprising at least one input device (64) and/or output device (65) with an acoustic and/or optical output element, for example a signal horn and/or warning lamp and/or speech output module.

51. System according to claim 34, wherein the at least one measuring unit (33) and the control system of the computer system of the warehouse management system and/or the control unit (63) and/or the drive system (37, 37′), in particular the controller of the drive motor (56; 60), are respectively provided with a transmitter and receiver unit for reciprocally transmitting data and/or signals wirelessly.

52. Method of dispensing stackable objects (2) in shaft-type dispenser magazines (13) of at least one storage unit (4) and monitoring the level (31) in the dispenser magazines (13) by means of a detection system (30), whereby the objects (2) are firstly stacked one on top of the other in shaft-type dispenser magazines (13) disposed one after the other in a row, after which they are dispensed individually by means of computer-controlled discharge mechanisms (21) disposed at the bottom end (20) of each of the dispenser magazines (13), wherein a control carriage (32) incorporating the detection system (30) is displaced in the longitudinal direction of the storage unit (4) above top ends (38) of the dispenser magazines (13) between the dispenser magazines (13) disposed one after the other in the displacement (46) of the control carriage (32), and as the control carriage (31) is being displaced, a distance (41) between the uppermost object (2) lying farthest away from the discharge mechanism (21) and a maximum, top level limit (42) of a dispenser magazine (13) is detected in at least one of the dispenser magazines (13) by means of at least one measuring unit (33) disposed on it and incorporating the detection system (30), after which the level (31) in this relevant dispenser magazine (13) is determined by the computer system.

53. Method according to claim 52, wherein, firstly, at least one type of object (2) forming part of an order is electronically detected by the computer system in a known manner, after which a desired stock level of objects (2) needed in the relevant dispenser magazine (13) and corresponding to the order is calculated by the computer system, and then a distance (41) between the uppermost object (2) lying farthest away from the discharge mechanism (21) and a maximum, top level limit (42) of a dispenser magazine (13) is measured without contact in at least the one dispenser magazine (13) containing the objects (2) for this order, the current level (31) in this relevant dispenser magazine (13) is determined and, taking account of the dimensions (45) of the objects (2) stacked one on top of the other in the stacking direction, the actual stock level of objects (2) in this relevant dispenser magazine (13) is calculated by the computer system, after which the actual stock level of objects (2) is compared with the desired stock level for this relevant dispenser magazine (13) and a demand message is issued to an operator to top up the relevant dispenser magazines (13) at the computer system and/or at a control unit (63) if the actual stock level of objects (2) falls short of the desired stock level of objects (2) needed for the order entered and/or will shortly fall short of it.

54. Method according to claim 52, wherein firstly, a sales quantity predicted by the computer system for at least one type of object (2) within a set time window is electronically detected, after which a desired stock level of objects (2) needed in the relevant dispenser magazine (13) corresponding to the predicted sales quantity is calculated by the computer system, and then a distance (41) between the uppermost object (2) lying farthest away from the discharge mechanism (21) and a maximum, top level limit (42) of a dispenser magazine (13) is measured in this relevant dispenser magazine (13) without contact, the current level (31) in this relevant dispenser magazine (13) is determined and, taking account of the dimensions (45) of the objects (2) stacked one on top of the other in the stacking direction, the actual stock level of objects (2) in this relevant dispenser magazine (13) is calculated by the computer system, after which the actual stock level of objects (2) is compared with the desired stock level for this relevant dispenser magazine (13) and a demand message is issued to an operator to top up the relevant dispenser magazine (13) at the computer system and/or at a control unit (63) if the actual stock level of objects (2) falls short of the desired stock level of objects (2) needed for the predicted sales quantity and/or will shortly fall below it.

55. Method according to claim 54, wherein a predicted sales quantity of several different objects (2) within a set time window is firstly electronically detected by the computer system, after which a desired stock level of objects (2) needed in the relevant dispenser magazines (13) corresponding to the predicted sales quantity is calculated by the computer system, and then a respective distance (41) between the uppermost object (2) lying farthest away from the discharge mechanism (21) and the maximum, top level limit (42) of a dispenser magazine (13) is determined in the relevant dispenser magazines (13) without contact, the respective current level (31) in the relevant dispenser magazines (13) is determined and, taking account of the dimensions (45) of the objects stacked one on top of the other in the stacking direction, the actual stock level of objects (2) in these relevant dispenser magazines (13) is calculated by the computer system, after which the respective actual stock level of objects (2) is compared with the desired stock level for these relevant dispenser magazines (13) and a demand message is issued to an operator to top up the relevant dispenser magazines (13) at the computer system and/or at a control unit (63) if the actual stock level of objects (2) falls short of the different objects (2) needed for the predicted sales quantity and/or will shortly fall short of it.

56. Method according to claim 53, wherein at least one order made up of several different objects (2) is firstly electronically detected by the computer system in a known manner, after which a desired stock level of objects (2) needed in the relevant dispenser magazines (13) corresponding to the order is calculated by the computer system, and then a distance (41) between the uppermost object (2) lying farthest away from the discharge mechanism (21) and a maximum, top level limit (42) of the dispenser magazines (13) is respectively measured without contact in at least the dispenser magazines (13) containing the objects (2) for the order, the current level (31) in these relevant dispenser magazines (13) is determined and, taking account of the dimensions (45) of the objects (2) stacked one on top of the other in the stacking direction, the actual stock level of objects (2) in these relevant dispenser magazines (13) is calculated by the computer system, after which the actual stock level of objects (2) is compared respectively with the desired stock level for these relevant dispenser magazines (13) and a demand message is issued to an operator to top up the relevant dispenser magazine (13) at the computer system and/or at a control unit (63) if the actual stock level of objects (2) in one of the dispenser magazines (13) falls short of the desired stock level of objects (2) needed for the order entered and/or will shortly fall short of it.

57. Method according to claim 53, wherein once the first order and at least one other order has been electronically detected by the computer system, a desired stock level of objects (2) needed in the relevant dispenser magazines (13) corresponding to the orders is calculated by the computer system, and then a distance (41) between the uppermost object (2) lying farthest away from the discharge mechanism (21) and a maximum, top level limit (42) of the dispenser magazines (13) is measured without contact respectively in at least the dispenser magazines (13) containing the objects (2) for the orders, the respective current level (31) in these relevant dispenser magazines (13) is determined and, taking account of the dimensions (45) of the objects (2) stacked one on top of the other in the stacking direction, the actual stock level of objects (2) in these relevant dispenser magazines (13) is calculated by the computer system, after which the actual stock level of objects (2) is compared with the desired stock level for these relevant dispenser magazines (13) and a demand message is issued to an operator to top up the relevant dispenser magazine (13) at the computer system and/or at a control unit (63) if the actual stock level of objects (2) in one of the dispenser magazines (13) falls short of the desired stock level of objects (2) needed for the orders entered and/or will shortly fall below it.

58. Method according to claim 53, wherein the demand message is output optically and/or acoustically and/or as a speech message.

59. Method according to claim 52, wherein distance (41) is measured only in that or those dispenser magazines (13) used to store and dispense the objects (2) sorted into consignments for the order or orders or for the predicted sales quantity, and the detected distance value of the relevant dispenser magazine or magazines (13) is transmitted to the computer system or a control unit (63).

60. Method according to claim 52, wherein the control carriage (32) approaches and is positioned at only that or those dispenser magazines (13) in which the objects (2) for the order or orders or the predicted sales quantity are stored and dispensed, and the detected distance value of the relevant dispenser magazine or magazines (13) is transmitted to the computer system or a control unit (63).

61. Method according to claim 52, wherein the control carriage (32) is moved continuously backwards and forwards in a pendulum motion between the first and last dispenser magazine (13) in its displacement direction (46) and the distance (41) for determining the level (31) is detected in each dispenser magazine (13) during its displacement from the first dispenser magazine (13) to the last dispenser magazine (13) and/or from the last dispenser magazine (13) to the first dispenser magazine (13), and the detected distance value of each dispenser magazine (13) is transmitted to the computer system or to a control unit (63).

62. Method according-to claim 52, wherein the control carriage (32) is moved backwards and forwards in a pendulum motion between the first and last dispenser magazine (13) in its displacement direction (46) at controlled time intervals and the distance (41) for determining the level (31) is detected in each dispenser magazine (13) during its displacement from the first dispenser magazine (13) to the last dispenser magazine (13) and/or from the last dispenser magazine (13) to the first dispenser magazine (13), and the detected distance value of each dispenser magazine (13) is transmitted to the computer system or to a control unit (63).
